(19) United States
(12) Patent Application Publication
(10) Pub. No.: US 2004/0135961 A1
(43) Pub. Date: Jul. 15, 2004

(54) Liquid crystal display having substrates with alignment layers

(76) Inventors: Ga-Lane Chen, Fremont, CA (US); Charles Leu, Fremont, CA (US); Tai-Cheng Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/745,265

(22) Filed: Dec. 22, 2003

(30) Foreign Application Priority Data
Dec. 20, 2002 (TW) 91136959

(51) Int. Cl. G02F 1/1337; G02F 1/1343

(52) U.S. Cl. 349/179; 349/141

(57) ABSTRACT

A liquid crystal display has two substrates (100, 200) opposite to each other and spaced apart a predetermined distance, a liquid crystal layer (300) between the two substrates and having a plurality of liquid crystal molecules (310), and a pair of electrodes (121, 122) formed on one of the substrates to provide an electrical field parallel to the substrates. Each substrate has an alignment layer formed thereon. Each alignment layer has a plurality of parallel grooves (190, 240) on its surface to orient the liquid crystal molecules. The grooves of one alignment layer are orthogonal to the grooves of the other alignment layer. When no voltage is provided, the overall arrangement of the liquid crystal molecules comprises a 90° twist. When a voltage is applied to the electrodes, an electrical field parallel to the substrate is formed, which rotates the liquid crystal molecules and makes the arrangement of the liquid crystal molecules homogeneous.

### BACKGROUND OF THE INVENTION

1. Field of the Invention

The present invention relates to liquid crystal displays (LCDs), and particularly to an LCD with in-plane switching (IPS) mode and providing a highly precise alignment of liquid crystal molecules therein.

2. Prior Art

In general, an LCD has two main advantages in comparison with cathode ray tubes (CRTs): LCDs are thin and have low power consumption. It has been said that LCDs might one day completely replace CRT display devices, and LCDs have aroused great interest in many industries in recent times.

However, LCDs generally provide a narrower viewing angle compared with CRT display devices. Various means have been devised in endeavoring to widen the viewing angle of LCDs.

One recently popular of such means is in-plane switching (IPS) mode. An LCD using IPS mode is based on a principle different from principles involved in other modes such as Twisted Nematic (TN) mode and Super Twisted Nematic (STN) mode. LCDs using these other modes are hereinafter collectively referred to “usual” LCDs.

In a usual LCD, an electric field is generated perpendicular to a principal surface of a substrate. When the electric field is selectively and locally applied on a liquid crystal layer, liquid crystal molecules in the liquid crystal layer are uniformly oriented perpendicular to the principal surface. Coexistence of these aligned liquid crystal molecules with unaligned liquid crystal molecules provides the visual contrast between black and white on the usual LCD.

On the other hand, the IPS LCD provides said contrast by horizontally and locally applying an electric field parallel to a principal surface. That is, the liquid crystal molecules of the liquid crystal layer are locally aligned or oriented along the parallel electric field. Specifically, each liquid crystal molecule, which can be represented by an oval shape, is rotated in a plane due to the parallel field. This results in rotation of an orientation vector of each liquid crystal molecule defined by a long axis of the liquid crystal molecule. The orientation vectors of the liquid crystal molecules are termed directors. The IPS LCD can decrease dependency of the viewing angle compared with the usual LCD. Specifically, dependency of the viewing angle is a function of the relationship between the viewing angle and the contrast.

An IPS LCD is disclosed in U.S. Pat. No. 6,285,428, and represented in FIG. 6 herein. The LCD includes a first substrate 42 having a first and a second electrodes 43, 44 formed thereon. A second substrate 420 is disposed opposite to and a selected distance from the first substrate 42. Liquid crystal molecules 450 are filled between the first and second substrates 42, 420. The second substrate 420 has a third and a fourth electrodes 430, 440 formed thereon. When a voltage is applied to the respective electrodes, a first electric field which is parallel to the planes of the substrates 42, 420 is generated between the first electrode 43 and the second electrode 44, and a second electric field which is parallel to the planes of the substrates 42, 420 and orthogonal to the first electric field is generated between the third electrode 430 and the fourth electrode 440. A polarizer 41 is arranged on the outside of the first substrate 42, and an analyzer 410 is arranged on the outside of the second substrate 420.

This IPS LCD has wider viewing angle characteristics than the usual LCD. However, the IPS LCD does not provide accurate alignment of the liquid crystal molecules parallel to the respective surfaces of the first and second substrates 42, 420. Therefore, the enlargement of the viewing angle is limited.

An improved IPS LCD overcoming the above-mentioned disadvantages is desired.

### SUMMARY OF THE INVENTION

An object of the present invention is to provide an LCD with IPS mode which yields accurate alignment of liquid crystal molecules therein.

To achieve the above object, a liquid crystal display has two substrates opposite to each other and spaced apart a predetermined distance, a liquid crystal layer between the two substrates and having a plurality of liquid crystal molecules, and a pair of electrodes formed on one of the substrates to provide an electrical field parallel to the substrates. The electrical field can rotate the liquid crystal molecules. Each substrate has an alignment layer formed thereon. Each alignment layer has a plurality of parallel grooves on its surface to orient the liquid crystal molecules. The grooves of two alignment layers are orthogonal to each other. When no voltage is provided, the overall arrangement of the liquid crystal molecules comprises a 90° twist. When a voltage is applied to the electrodes, an electrical field parallel to the substrate is formed, which rotates the liquid crystal molecules and makes the arrangement of the liquid crystal molecules homogeneous.

Other objects, advantages and novel features of the invention will become more apparent from the following detailed description when taken in conjunction with the accompanying drawings.

### BRIEF DESCRIPTION OF THE DRAWINGS

FIG. 1 is a schematic, cross-sectional view of part of an LCD with IPS mode in accordance with a preferred embodiment of the present invention;

FIG. 2 is an isometric view of a second alignment film of the LCD of FIG. 1;

FIG. 3 is an isometric view of a first alignment film of the LCD of FIG. 1;

FIG. 4 is an exploded, isometric view of the LCD of FIG. 1, showing orientations of liquid crystal molecules thereof when no voltage is applied;

FIG. 5 is similar to FIG. 4, but showing orientations of the liquid crystal molecules when a voltage is applied; and

FIG. 6 is an exploded, isometric view of part of a conventional LCD.

### DETAILED DESCRIPTION OF THE PREFERRED EMBODIMENT

Hereinafter, a preferred embodiment of the present invention will be explained in more detail with reference to the accompanying drawings.

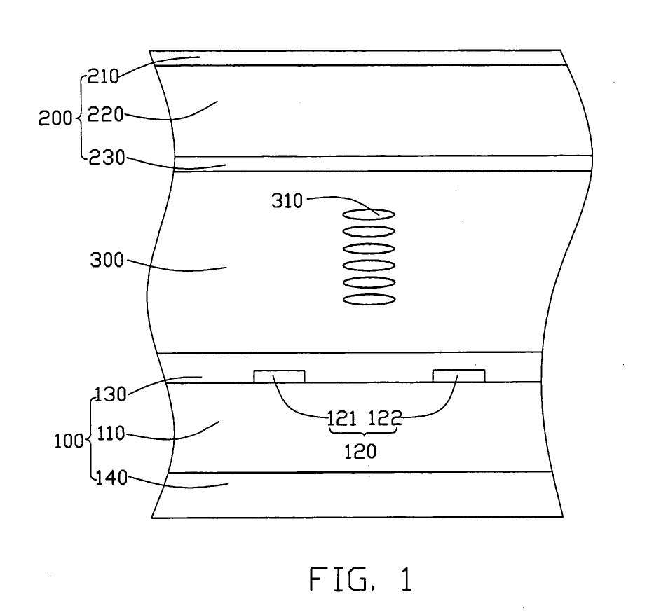

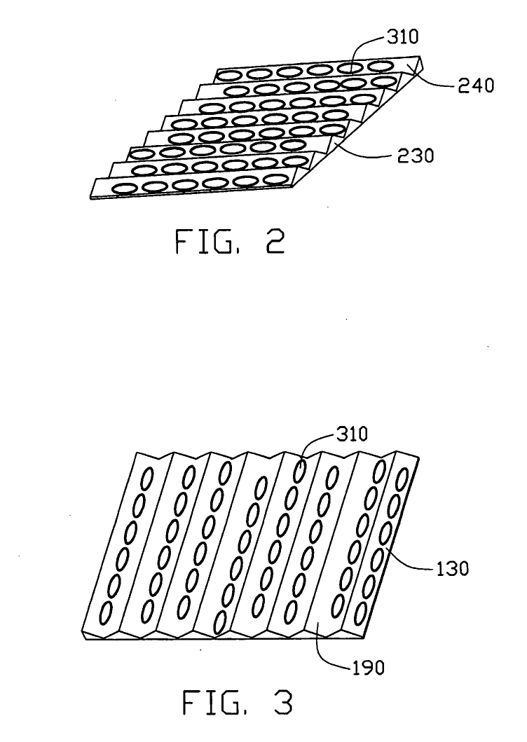

As shown in FIGS. 1, 2 and 3, an LCD with an IPS mode according to the present invention comprises a first substrate 100, a second substrate 200 opposite to and spaced a predetermined distance from the first substrate 100, a liquid crystal layer 300 filled and installed between the first and the second substrates 100, 200, which has a plurality of liquid crystal molecules 310 .

The first and the second substrates 100, 200 respectively comprise a first glass plate 110 having a first principle surface (not labeled) and a second glass plate 220 having a second principle surface (not labeled). A polarizer 140 and an analyzer 210 are respectively arranged on outsides of the first and second glass plates 110, 220. Polarization axes of the polarizer 140 and the analyzer 210 are orthogonal to each other.

Furthermore, a pixel electrode 121 and a common electrode 122 are formed on the first glass plate 110. The pixel electrode 121 and the common electrode 122 are spaced from each other a selected distance and are parallel to each other. This configuration is for generating an electric field substantially parallel to the first principal surface (and the second principal surface) in a predetermined space in order to rotate the liquid crystal molecules 310 in accordance with the electric field.

A first alignment film 130 and a second alignment film 230 are respectively applied to the first and second principal surfaces of the first and second glass plates 110, 220, in order to align the liquid crystal molecules 310 respectively. The first and second alignment films 130, 230 are disposed opposite to each other with a predetermined space therebetween. The first alignment film 130 is subjected to a first aligning treatment, and the second alignment film 230 is subjected to a second aligning treatment in a direction orthogonal to a direction of the first alignment treatment.

Pluralities of parallel first and second grooves 190, 240 are respectively formed on surfaces of the first and second alignment films 130, 230 that are adjacent to the liquid crystal layer 300. The first grooves 190 have a first directional orientation, and the second grooves 240 have a second directional orientation orthogonal to the first directional orientation. A pitch and a height of the first and second grooves 190, 240 match those of the liquid crystal molecules 310, to realize alignment of the liquid crystal molecules 310. That is, long axes of the liquid crystal molecules 310 can be oriented parallel to surfaces of the first and second grooves 190, 240.

In assembly, the liquid crystal molecules 310 are interposed and sealed between the first and second substrates 100, 200, and cooperatively oriented by the first and second alignment films 130, 230, respectively. In particular, certain of the liquid crystal molecules 310 adjacent to the first alignment film 130 are oriented by the first grooves 190 with a first directional orientation, while certain other of the liquid crystal molecules 310 adjacent to the second alignment film 230 are oriented by the second grooves 240 with a second directional orientation that is orthogonal to the first directional orientation. Therefore, the liquid crystal molecules 310 are progressively twisted 90 degrees as between the first and second alignment films 130, 230.

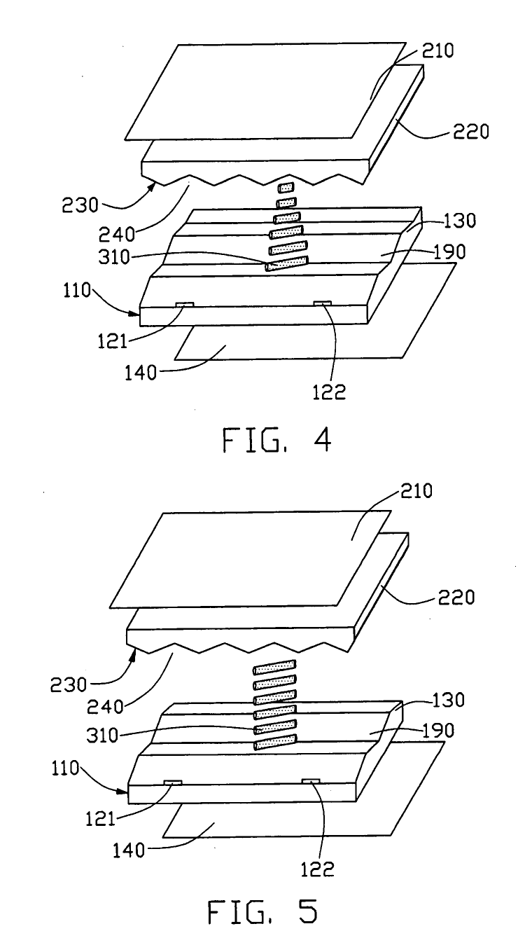

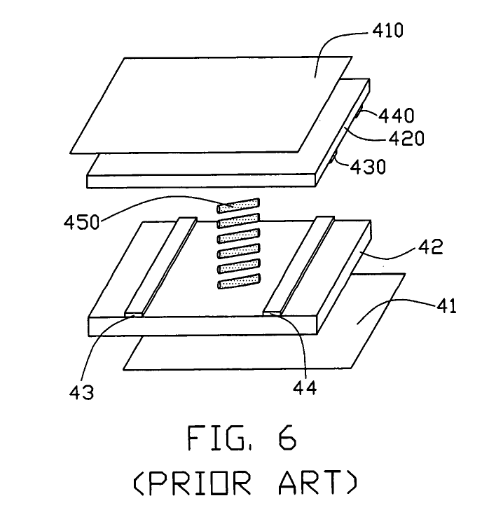

As shown in FIG. 4, in operation, when voltage is not applied to the electrodes 121, 122, the liquid crystal molecules 310 adjacent to the first alignment film 130 are orientated along the first grooves 190 with the first directional orientation, and the liquid crystal molecules 310 adjacent to the second alignment film 230 are oriented along the second grooves with the second directional orientation orthogonal to the first directional orientation. That is, the overall arrangement of the liquid crystal molecules 310 comprises a 90° twist due to the first and second grooves 190, 240 of the first and second alignment films 130, 230 being orthogonal to each other. Accordingly, incident light which has been changed to linearly polarized light at the polarizer 140 changes to elliptically polarized light when it passes through the liquid crystal layer 300, and a display of the LCD is bright because most of the incident light passes through the analyzer 210.

On the other hand, as shown in FIG. 5, when voltage is applied to the electrodes 121, 122, an electrical field in a direction of the cell that is parallel to the principle surface of the first substrate 100 is formed between the pixel electrode 121 and the common electrode 122. The arrangement of the liquid crystal molecules 310 is homogeneous due to the parallel electrical field, and the optical axes of the liquid crystal molecules 310 are fully aligned with the polarization axis of the polarizer 140. Therefore, incident light which has been changed to linearly polarized light at the polarizer 140 reaches the analyzer 210 unchanged due to the homogeneous arrangement of the liquid crystal molecules 310. A display of the LCD is dark because the linearly polarized incident light is not in accord with the polarization axis of the analyzer 210, and cannot pass therethrough.

A method for manufacturing the first and second alignment films 130, 230 comprises the following steps: firstly, coating a layer of polyimide on the first and second substrates 110, 220; secondly, forming a plurality of parallel V-shaped first and second grooves 190, 240 on the polyimide layer by a mechanical method, in which the first grooves 190 of the first alignment film 130 have the first directional orientation, and the second grooves 240 of the second alignment film 230 have the second directional orientation. The depth and the pitch of the first and second grooves 190, 240 match those of the liquid crystal molecules 310. This enables the liquid crystal molecules 310 to align parallel to the respective principle surfaces of the substrates 110, 220. Furthermore, the second grooves 240 can be directly formed on the second substrate 220 without coating a polyimide layer thereon.

As above described, the LCD with IPS mode according to the present invention has wide view-angle characteristics, because the liquid crystal molecules 310 are progressively twisted from positions in which their longitudinal axes are adjacent and parallel to the first grooves 190 of the first substrate 100 to positions in which their longitudinal axes are adjacent and parallel to the second grooves 240 of the second substrate 200.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A liquid crystal display comprising:
two substrates opposite to each other and spaced apart a predetermined distance, each of the substrates having an alignment layer;
a liquid crystal layer between the two substrates, and having a plurality of liquid crystal molecules; and
a pair of electrodes formed on one of the substrates;
wherein each of the alignment layers has a plurality of parallel grooves on its surface for orienting the liquid crystal molecules, therefore, when no voltage is provided, the overall arrangement of the liquid crystal molecules comprises a 90° twist; when a voltage is applied to the electrodes, an electrical field parallel to the substrate is formed, which rotates and orients the liquid crystal molecules, and makes the arrangement of the liquid crystal molecules homogeneous.

2. The liquid crystal display of claim 1, wherein the grooves of the alignment layers have V-shaped profiles.

3. The liquid crystal display of claim 1, wherein a pitch of the grooves matches that of the liquid crystal molecules.

4. The liquid crystal display of claim 3, wherein a height of the grooves matches that of the liquid crystal molecules.

5. The liquid crystal display of claim 1, wherein the grooves of each of the alignment layers are parallel to each other, and the grooves of the two alignment layers are perpendicular to each other.

6. The liquid crystal display of claim 1, wherein the two alignment layers orient the liquid crystal molecules when no voltage is applied.

7. The liquid crystal display of claim 1, wherein the alignment layers are made from polyimide.

8. The liquid crystal display of claim 1, wherein at least one of the alignment layers is directly formed on the corresponding substrate by mechanical processing.

9. A method for manufacturing an alignment film on a substrate of an LCD comprises the following steps:
coating a layer of polyimide on a substrate;
mechanically processing a plurality of V-shaped grooves on the polyimide layer.

10. The method for manufacturing an alignment film of claim 9, wherein the depth of the grooves match that of liquid crystal molecules in the LCD.

11. The method for manufacturing an alignment film of claim 9, wherein the pitch of the grooves match that of liquid crystal molecules in the LCD.

12. A liquid crystal display comprising:
at least one substrate;
a pair of spaced pixel and common electrodes formed in said substrate and in a parallel relation with each other, said pair of electrodes defining an electrical field along a direction;
an alignment layer formed on said substrate;
a plurality of liquid crystal molecules disposed on said alignment layer and affected by said alignment layer to be commonly arranged along said direction before said electrical field is applied thereto.

13. The liquid crystal display of claim 12, wherein said pair of electrodes are covered by said alignment layer.

14. The liquid crystal display of claim 12, wherein another substrate is spaced positioned above said substrate and is equipped with another alignment layer.

15. The liquid crystal display of claim 12, wherein said alignment layer is essentially a surface texture applied to the substrate.

16. The liquid crystal display of claim 15, wherein said surface texture defines a plurality of spaced parallel V-shaped grooves extending along said direction.
